(19) United States
(12) Patent Application Publication
(10) Pub. No.: US 2023/0086083 A1
(43) Pub. Date: Mar. 23, 2023

(54) METHOD FOR GENERATING A PHYSICAL MODEL OF A PATH FROM GPS DATA

(71) Applicant: DEEP BLUE MAPS PTY LTD, Burleigh Heads (AU)

(72) Inventors: Kristian James Weegink, Kedron (AU); Thomas David Percy, Burleigh Heads (AU)

(73) Assignee: DEEP BLUE MAPS PTY LTD, Burleigh Heads (AU)

(21) Appl. No.: 17/946,649

(22) Filed: Sep. 16, 2022

(30) Foreign Application Priority Data
Sep. 17, 2021 (AU) 2021903006

(51) Int. Cl. G01S 19/24; G01S 19/31

(52) U.S. Cl. CPC G01S 19/243; G01S 19/31

(57) ABSTRACT

A method for generating a physical model of a path from GPS data. The method involves receiving GPS data defining a path from a GPS-enabled device and receiving a digital terrain model for an area that includes the path. An area of interest along the path is then identified and the GPS data associated with the area of interest is smoothed. The digital terrain model is sampled along the path and an elevation of the path is smoothed using a weighted average of the digital terrain model and the GPS data to create modified path data that is scaled to produce a first ribbon that is printed.

### TECHNICAL FIELD

The present invention relates to a method for generating a physical three-dimensional (3D) model of a path from GPS data and a digital terrain model.

### BACKGROUND

Any references to methods, apparatus or documents of the prior art are not to be taken as constituting any evidence or admission that they formed, or form part of the common general knowledge.

Creating miniature maps and models of popular and memorable hiking tracks and walking trails is popular among many. However, creating these models can be time consuming and technically difficult, and often produces lacklustre results due to the limited accuracy and/or availability of GPS data or the erratic and unpredictable nature of the hiker or the path being traversed.

Thus, there is a need for an improved way to generate three-dimensional models of traversed paths, such as hiking trails and walking tracks.

### SUMMARY OF INVENTION

In an aspect, the invention provides a method for generating a physical model of a path from GPS data, the method including the steps of:

receiving GPS data defining a path from a GPS-enabled device;

receiving a digital terrain model for an area including the path;

identifying an area of interest along the path and applying a first smoothing function to the GPS data associated with the area of interest;

applying a second smoothing function to the GPS data to approximate the path;

sampling the digital terrain model along the path;

applying a third smoothing function to an elevation of the path using a weighted average of the digital terrain model and the GPS data to produce modified path data;

scaling elevation, latitude and longitude associated with the modified path data to predetermined dimensions to produce a first ribbon; and

printing a physical 3D model based on the first ribbon.

Preferably, the method includes the steps of scaling the scaled modified path data in one or more planes to produce a second ribbon;

combining the first ribbon and the second ribbon to generate a digital 3D model of the path; and

printing a physical 3D model based on the digital 3D model of the path.

Preferably, scaling the scaled path data comprises scaling in the x, y and z planes or directions. More preferably, the scaled path data is scaled to produce a second ribbon which is wider (in the x,y plane) than the first ribbon and having a height less than the first ribbon (lower in the z plane).

Preferably, combining the first ribbon and the second ribbon include superimposing the first ribbon and the second ribbon.

Preferably, the third smoothing function comprises a Kalman filter. Preferably, the Kalman filter is applied forward and reverse in time.

Preferably, the GPS data comprises latitudinal, longitudinal and elevation data associated with the path. Preferably, the digital terrain model comprises latitudinal and/or longitudinal and/or elevation data associated with the area including the path.

In another aspect, the invention provides a method for generating a physical model of a path from GPS data, the method including the steps of:

receiving GPS data defining a path from a GPS-enabled device;

receiving a digital terrain model for an area including the path;

identifying an area of interest along the path and smoothing the GPS data associated with the area of interest;

smoothing the GPS data to approximate the path;

sampling the digital terrain model along the path;

smoothing an elevation of the path using a weighted average of the digital terrain model and the GPS data to produce modified path data;

scaling the modified path data to predetermined dimensions to produce a first ribbon; and

printing a physical 3D model based on the first ribbon.

In another aspect, the invention provides a system for generating a physical model of a path from GPS data, the system comprising:

a GPS-enabled device programmed to generate GPS data defining a path;

a computer programmed to:
receive the GPS data from the GPS-enabled device;
receive a digital terrain model for an area including the path;
identify an area of interest along the path and smooth the GPS data associated with the area of interest;
smooth the GPS data to approximate the path;
sample the digital terrain model along the path;
smooth an elevation of the path using a weighted average of the digital terrain model and the GPS data to produce modified path data; and
scale the modified path data to predetermined dimensions to produce a first ribbon; and

a printer adapted to receive the first ribbon and print a physical 3D model based on the first ribbon.

Preferably, the computer is further configured to scale the scaled modified path data in one or more planes to produce a second ribbon;

combine the first ribbon and the second ribbon to generate a digital 3D model of the path; and

the printer is adapted to receive the digital 3D model and print a physical 3D model based on the digital 3D model of the path.

Preferably, the computer is further configured to scale the scaled modified path data in the x, y and z planes or directions.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a system for generating a physical model of a path from GPS data;

FIG. 2 illustrates a block diagram of the system of FIG. 1;

FIG. 3 illustrates a smoothing function applied to the GPS data to remove movements around a small area;

FIG. 4 illustrates a second smoothing function applied to the GPS data to form a smooth path from the GPS data;

FIG. 5 illustrates a third smoothing function applied to the elevation of the GPS data combined with a digital terrain model;

FIG. 6 illustrates a physical model of a path generated from GPS data; and

FIG. 7 illustrates another view of the physical model of the path generated from GPS data.

### DETAILED DESCRIPTION OF PREFERRED EMBODIMENTS

The present disclosure relates to a method of forming a physical model of a predefined path (such as a walking track) from a traversed path and a digital elevation model. Generally, the disclosure provides a method of forming a scaled physical model of a predefined path.

Exemplary embodiments of the invention include a method for forming a physical model of a predefined path. The method includes generating a digital elevation model of a topography of a predefined path, such as a popular hiking trail that a customer wishes to have represented in a physical model.

The method involves obtaining a digital elevation model or digital terrain model (including three-dimensional digital height data) for a path that a person has traversed or defined in some way.

Next, the path is converted into a two-dimensional form (a line) and smoothed, algorithmically, to provide an aesthetically pleasing track. More specifically, areas of interest (including sections of the path or data which show large jumps in position or small changes in position) are identified and smoothed. As an example, the smoothing removes criss-crossing paths so that the path appears more linear. This step can be performed either manually or automatically by the computer.

The height of the line is then sampled based on the digital elevation model and extruded to create a 3D representation of the path.

Finally, the 3D representation is provided to a tool or machine (such as a 3D printer, for example) which produces a physical, 3D model of the path.

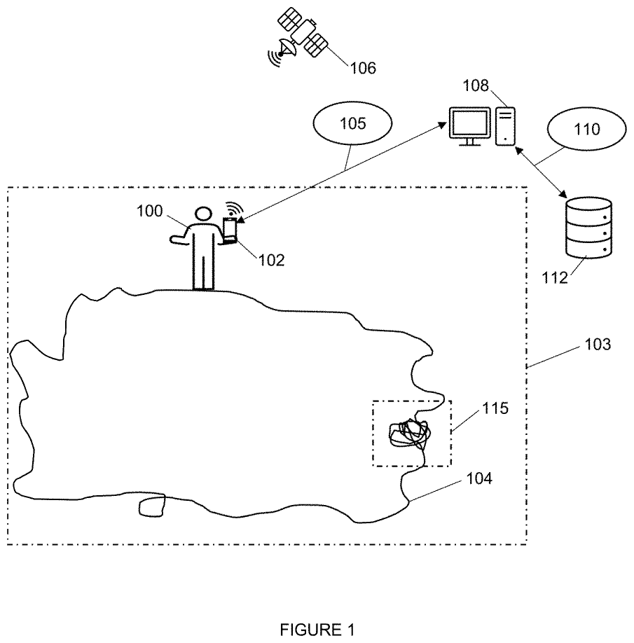

Referring now to FIG. 1, there is illustrated a person 100 having a GPS-enabled smartphone 102 who has traversed a path 104. While the person 100 traversed the path 104, the smartphone 102 records GPS data in the form of path data 105 associated with the path 104 by communicating with GPS satellites 106.

The path data 105 includes latitudinal, longitudinal and elevation data associated with the path 104.

The path data is then communicated to a computer 108 which is programmed to receive the path data 105 and produce a three-dimensional (3D) representation of the path 104 that can then be used to generate a physical, 3D model of the path 104, through printing, for example.

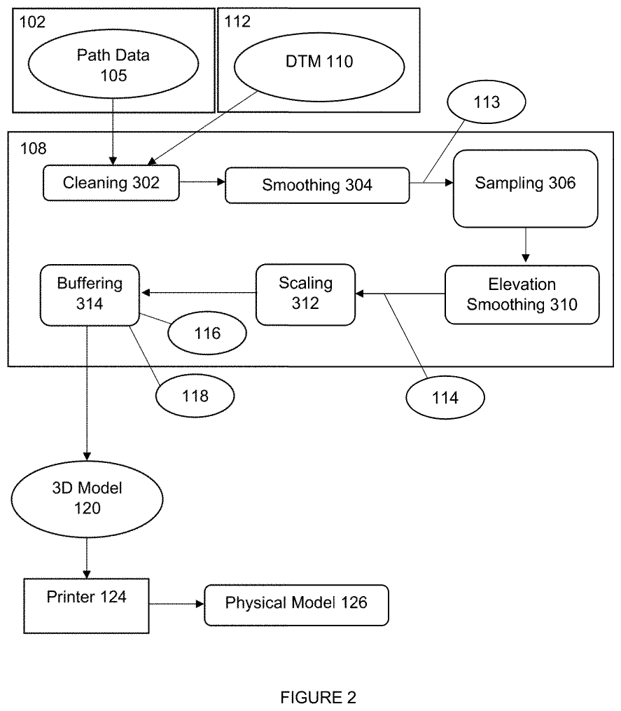

FIG. 2 illustrates this process in greater detail.

As shown, smartphone 102 provides path data 105 to the computer 108, which is adapted to perform a series of tasks and steps to produce a digital three-dimensional (3D) representation of the path 104. The path data 105 is preferably provided in either GPS Exchange Format (GPX) or NMEA Format (National Marine Electronics Association).

The computer 108 also obtains a digital elevation model or digital terrain model 110 (DTM) from a database 112. The DTM 110 relates to an area 103 (such as a specific geographic area or region) including the path 104.

The DTM 110 includes 3D digital height data (i.e. elevation data) for the area 103 that is later used to provide depth to the model and this will be explained in greater detail below. In some embodiments, DTM 110 includes latitudinal, longitudinal and elevation data associated with the area including the path.

The DTM 110 can be obtained from a number of known sources. One such source is the ALOS Global Digital Surface Model. However, it will be appreciated that any number of digital surface models could be utilised.

First, a cleaning step 302 is performed. The cleaning step 302 identifies and removes areas of interest in the path data 105. The areas of interest include sections of the path data 105 representing the path 104 where there are large, discontinuous changes in position and/or small changes in position over a period of time. These small changes often represent standing in place or walking around a small area. It is desirable to remove the large jumps as they will create discontinuities within the final model. Removing the small changes is advantageous as it creates a cleaner final model without messy tracks that excessively criss-cross.

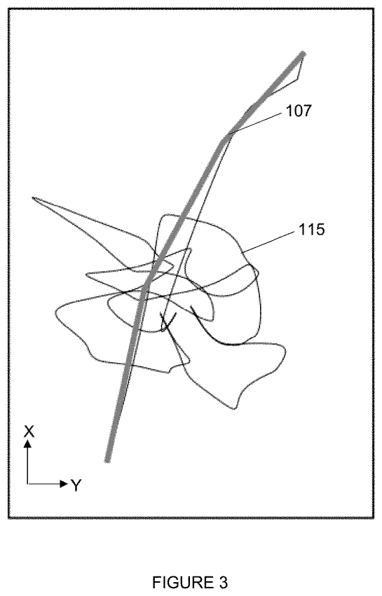

In particular, where the path data 105 indicates that the user has remained in one position for an extended period of time, the path data 105 can be smoothed by applying a spline 107 which provides a smooth line from a set of data points. An example of this can be seen in FIG. 3 where area of interest 115 has been identified along the path 104 and a cubic spline 107 has been applied to smooth the area of the interest 115.

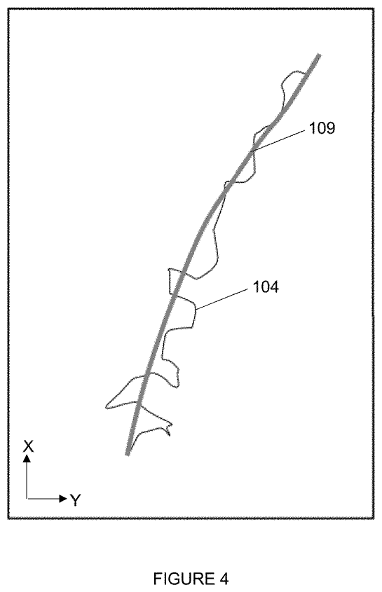

Next, the entirety of the path data 105 undergoes a smoothing step 304. In particular, the longitudinal and latitudinal data of the path 105 is smoothed by fitting another cubic spline 109 which approximates the path 104 to create a first smoothed path 113. A cubic spline is a piecewise cubic function which interpolates a set of data points to provide a smooth path from those data points. An example of the track smoothing can be seen in FIG. 4.

Subsequently, a sampling step 306 is performed. Sampling step 306 includes sampling the DTM 110 along the first smoothed path 113.

An elevation smoothing step 310 is then performed by computer 108. Elevation smoothing step 310 includes smoothing the elevation along the smoothed path 113 by fitting a cubic spline 111 to the smoothed path 113 using a weighted average of the DTM 110 and the path 102.

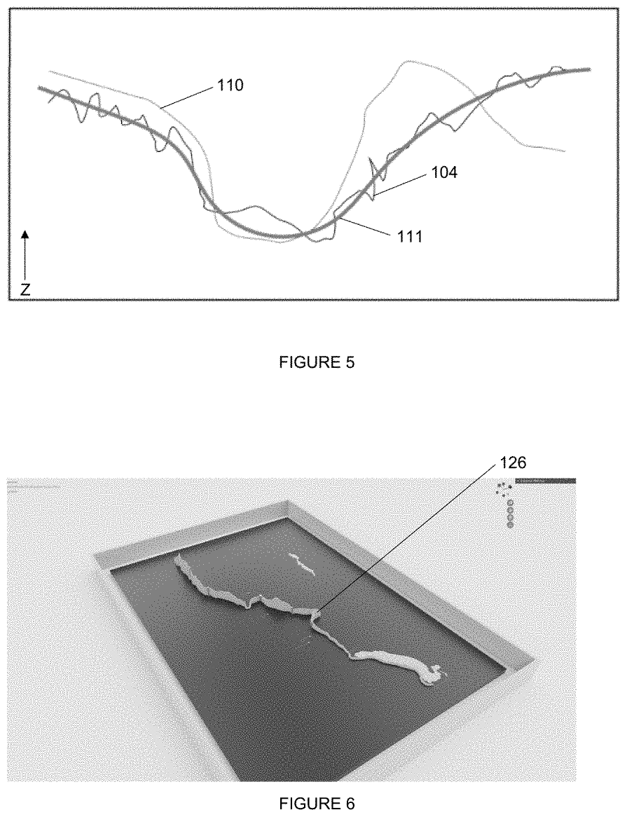

More specifically, the elevation smoothing step 310 includes applying a Kalman Filter to the path data 102 both forward and reverse in time. The DTM 110 is included as an estimation state which allows the final path to be a combination of the heights provided in the path data 105 and the DTM 110. A second smoothed path 114 is thus generated. An example of the elevation smoothing can be seen in FIG. 5.

At the next step, the computer 108 executes a scaling step 312. Scaling step 312 includes scaling the second smoothed path 114 to the size of a physical canvas that the final physical model will fill. The scaling occurs in the x- and y-planes so that the final physical model is a desired size. As an example, the canvas may be 400 mm×300 mm and the second smoothed path 114 will be scaled to fit the canvas accordingly.

The computer 108 scales the second smoothed path 114 to predetermined dimensions M, N in the x- and y-planes in the range of [M,N]. The predetermined dimensions may be any value as defined by a customer or designer.

The second smoothed path 114 is also scaled in the z-plane (i.e. elevation/height) to a predetermined height (H) in the range of [0,H], where H is defined by the predetermined height of the physical model. In a preferred embodiment, the height is anywhere between 0 mm and 35 mm.

At buffering step 314, the scaled second smoothed path 114 is then transformed into a plane by creating an offset at each side of the scaled second smoothed path 114 by the normal at each point along the scaled second smoothed path 114. Put another way, the scaled second smoothed path 114 is buffered perpendicularly in the x and y directions by a predefined distance (preferably 3 mm) to create the first 3D ribbon 116.

Next, the plane is scaled and projected down to the canvas to create a first 3D ribbon 116 that represents the heights along the scaled second smoothed path 114.

In some embodiments, the first 3D ribbon 116 can be sent directly to the printer 124 for printing to produce a physical model 126.

In some embodiments, a second, wider 3D ribbon 118 is produced by scaling the first 3D ribbon 116 (or the scaled second smoothed path 114) in the x,y directions (to produce a wider ribbon) and further scaled to a lower height in the z-direction. The scaled second smoothed path 114 is evenly sampled and the heights in the z-direction are filtered using a low-pass filter.

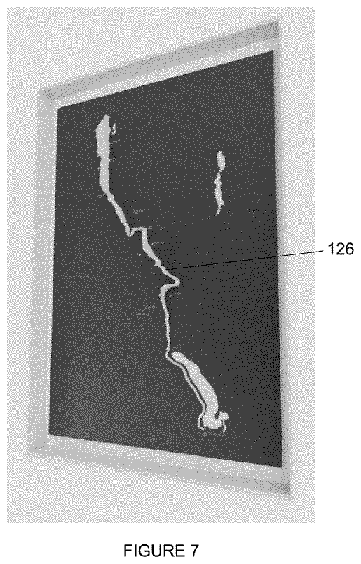

Finally, the first 3D ribbon 116 and the second 3D ribbon 118 are combined by superimposing the first 3D ribbon 116 and the second 3D ribbon 118 to form a 3D model 120 which can be printed with a printer, such as a resin printer 124, for example, to produce a physical 3D model 126 representative of the traversed path 104. Examples of the physical model of the traversed path produced from the superposition of the first 3D ribbon 116 and the second 3D ribbon 118 can be seen in FIGS. 6 and 7. The physical 3D model is a physical recreation of the path 104 but is not necessarily an exact replica of the path 104.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1. A method for generating a physical model of a path from GPS data, the method including the steps of:
receiving GPS data defining a path from a GPS-enabled device;
receiving a digital terrain model for an area including the path;
identifying an area of interest along the path and applying a first smoothing function to the GPS data associated with the area of interest;
applying a second smoothing function to the GPS data to approximate the path;
sampling the digital terrain model along the path;
applying a third smoothing function to an elevation of the path using a weighted average of the digital terrain model and the GPS data to produce modified path data;
scaling elevation, latitude and longitude associated with the modified path data to predetermined dimensions to produce a first ribbon; and
printing a physical 3D model based on the first ribbon.

2. The method of claim 1, wherein the method includes the steps of:
scaling the scaled modified path data in one or more planes to produce a second ribbon;
combining the first ribbon and the second ribbon to generate a digital 3D model of the path; and
printing a physical 3D model based on the digital 3D model of the path.

3. The method of claim 2, wherein scaling the scaled modified path data comprises scaling in the x, y and z planes or directions.

4. The method of claim 3, wherein the scaled modified path data is scaled to produce a second ribbon which is wider (in the x,y plane) than the first ribbon and having a height less than the first ribbon (lower in the z plane).

5. The method of claim 2, wherein combining the first ribbon and the second ribbon included superimposing the first ribbon and the second ribbon.

6. The method of claim 1, wherein the third smoothing function comprises a Kalman filter.

7. The method of claim 6, wherein the Kalman filter is applied forward and reverse in time.

8. The method of claim 1, wherein the GPS data comprises latitudinal, longitudinal and elevation data associated with the path.

9. The method of claim 1, wherein the digital terrain model comprises latitudinal and/or longitudinal and/or elevation data associated with the area including the path.

10. A system for generating a physical model of a path from GPS data, the system comprising:
a GPS-enabled device programmed to generate GPS data defining a path;
a computer programmed to:
receive the GPS data from the GPS-enabled device;
receive a digital terrain model for an area including the path;
identify an area of interest along the path and smooth the GPS data associated with the area of interest;
smooth the GPS data to approximate the path;
sample the digital terrain model along the path;
smooth an elevation of the path using a weighted average of the digital terrain model and the GPS data to produce modified path data; and
scale the modified path data to predetermined dimensions to produce a first ribbon; and
a printer adapted to receive the first ribbon and print a physical 3D model based on the first ribbon.

11. The system of claim 1, wherein the computer is further configured to scale the scaled modified path data in one or more planes to produce a second ribbon;
combine the first ribbon and the second ribbon to generate a digital 3D model of the path; and
the printer is adapted to receive the digital 3D model and print a physical 3D model based on the digital 3D model of the path.

12. The system of claim 11, wherein the computer is further configured to scale the scaled modified path data in the x, y and z planes or directions.

13. The system of claim 12, wherein the scaled modified path data is scaled to produce a second ribbon which is wider (in the x,y plane) than the first ribbon and having a height less than the first ribbon (lower in the z plane).

14. The system of claim 11, wherein combining the first ribbon and the second ribbon include superimposing the first ribbon and the second ribbon.

15. The system of claim 10, wherein the third smoothing function comprises a Kalman filter.

16. The system of claim 15, wherein the Kalman filter is applied forward and reverse in time.

17. The system of claim 10, wherein the GPS data comprises latitudinal, longitudinal and elevation data associated with the path.

18. The system of claim 10, wherein the digital terrain model comprises latitudinal and/or longitudinal and/or elevation data associated with the area including the path.

19. A method for generating a physical model of a path from GPS data, the method including the steps of:
receiving GPS data defining a path from a GPS-enabled device;
receiving a digital terrain model for an area including the path;
identifying an area of interest along the path and smoothing the GPS data associated with the area of interest;
smoothing the GPS data to approximate the path;
sampling the digital terrain model along the path;
smoothing an elevation of the path using a weighted average of the digital terrain model and the GPS data to produce modified path data;
scaling the modified path data to predetermined dimensions to produce a first ribbon; and
printing a physical 3D model based on the first ribbon.
